(19) United States
(12) Patent Application Publication
(10) Pub. No.: US 2021/0259340 A1
(43) Pub. Date: Aug. 26, 2021

(54) Computer Process for Generating Fashion Pattern from an Input Image of a Design Element

(71) Applicant: Savitude, Inc., Palo Alto, CA (US)

(72) Inventors: Nicholas Daniel Clayton, Ypsilanti, MI (US); Camilla Marie Olson, Palo Alto, CA (US); Jungah Joo Lee, Lake Oswego, OR (US); Shen Liu, Ann Arbor, MI (US)

(21) Appl. No.: 17/181,636

(22) Filed: Feb. 22, 2021

Related U.S. Application Data
(60) Provisional application No. 62/980,107, filed on Feb. 21, 2020.

(51) Int. Cl. A41H 3/00; G06K 9/46; G06K 9/62; G06T 7/12; G06T 7/149; G06T 11/40; G06F 30/12; G06N 3/08; G06T 7/00

(52) U.S. Cl. CPC A41H 3/007; G06K 9/4604; G06K 9/6267; G06T 7/12; G06T 7/149; G06T 11/40; G06T 2200/24; G06N 3/08; G06T 7/0004; G06T 2207/20081; G06T 2207/30108; G06T 2207/20084; G06F 30/12

(57) ABSTRACT

An automated pattern generation application obtains an image as an input, where the image is of a design element such as a unique building. The automated pattern generation application extracts essential design features from the image and determines how to represent those essential design features in a fashion object (e.g., a garment or wearable accessory).

### CROSS-REFERENCE TO RELATED APPLICATION

This application claims the benefit of the filing date of, and priority to, U.S. Application No. 62/980,107, filed Feb. 21, 2020, the entire disclosure of which is hereby incorporated herein by reference.

### FIELD OF THE INVENTION

The present invention relates generally to an improved technological process involving a computer processes for generating fashion patterns that could be used for manufacturing garments or accessories and more specifically to methods and apparatus for generating a fashion pattern and/or a garment or accessory from a design element.

### BACKGROUND

Fashion patterns might take the form of shaped material that is used to cut and sew fabric, among other uses. A resulting garment will have a look that can in part be attributed to the fashion pattern used. Sometimes fashion patterns are simple and sometimes they are complex. Generally, the technological process for generating fashion patterns is manual via pen/pencil and paper or via electronic sketching programs. There are currently no computer technologies that automate the creation and generation of fashion patterns.

### BRIEF DESCRIPTION OF THE DRAWINGS

FIG. 1 is a diagrammatic illustration of a data flow involving an automated pattern generation system according to an example embodiment.

FIG. 2 is a diagrammatic illustration of the automated pattern generation system according to an example embodiment, the system including a remote user device comprising a graphical user interface (“GUI”) that is configured to display a plurality of windows.

FIG. 3 a flow chart illustration of a method of operating the system of FIGS. 1-2, according to an example embodiment.

FIG. 4 is an illustration of an input image, according to an example embodiment.

FIG. 5 is an illustration of an input image, according to another example embodiment.

FIG. 6 is diagrammatic illustration depicting a step of the method of FIG. 3, according to an example embodiment.

FIG. 7 is diagrammatic illustration depicting a step of the method of FIG. 3, according to an example embodiment.

FIG. 8 is diagrammatic illustration depicting a step of the method of FIG. 3, according to an example embodiment.

FIG. 9 is diagrammatic illustration depicting a step of the method of FIG. 3, according to an example embodiment.

FIG. 10 is diagrammatic illustration depicting a step of the method of FIG. 3, according to an example embodiment.

FIG. 11 is an illustration of a window displayed on the GUI of the remote user device of FIG. 2 during another step of the method of FIG. 3, according to an example embodiment.

FIGS. 12A-12C are diagrammatic illustrations depicting a step of the method of FIG. 3, according to an example embodiment.

FIG. 13 is a diagrammatic illustration of the remote user device of FIG. 2, according to an example embodiment.

FIG. 14 is a diagrammatic illustration of a node for implementing one or more example embodiments of the present disclosure, according to an example embodiment.

### DETAILED DESCRIPTION

Various embodiments are described herein and additional variations should be apparent to the reader. In a process described herein, which might be used by a fashion designer, an automated pattern generation system can generate a fashion pattern, or construct a garment directly, from inputs derived from images of objects such as buildings and structures as well as other user inputs. The design element of an object in an image might be just a part of a garment.

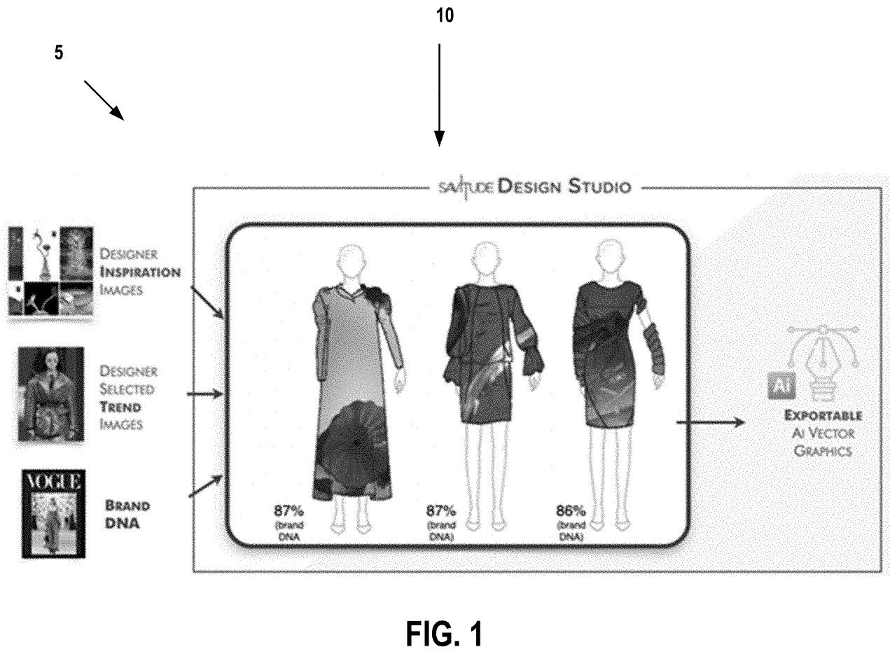

In an example embodiment, referring to FIG. 1, a diagrammatic illustration of a data flow 5 involving an automated pattern generation system 10 involves receiving inputs from a user. The inputs may include user, or designer, inspiration images; designer selected trend images; and brand DNA inputs. The automated pattern generation system then generates garment patterns based on the user inputs. In some embodiments, the automated pattern generation system uses artificial intelligence (“AI”) to generate the garment patterns. The automated pattern generation system also displays the garment patterns to the user via a graphical user interface. Additionally, the automated pattern generation system may generate exportable AI vector graphics. The automated pattern generation system results is an improved technological process in part because of the unique combination of steps that are completed to generate the garment pattern. That is, the ordering and combination of the steps described below result in a technical improvement. In some embodiments, the automated pattern generation system 10 creates a garment pattern with design details or features that correspond to features found in the user inputs, such as the designer inspiration images, the designer selected trend images, and/or brand DNA inputs. The design details or features found in the garment pattern might be selected from one image of a plurality of “inspiration images.” In some implementations, the selection may be done by a human designer, while in other implementations, the selection may be done by the automated pattern generation system 10 such as a random selection or computing to fit certain automated criterion consistent with, for example, a trend or brand aesthetics.

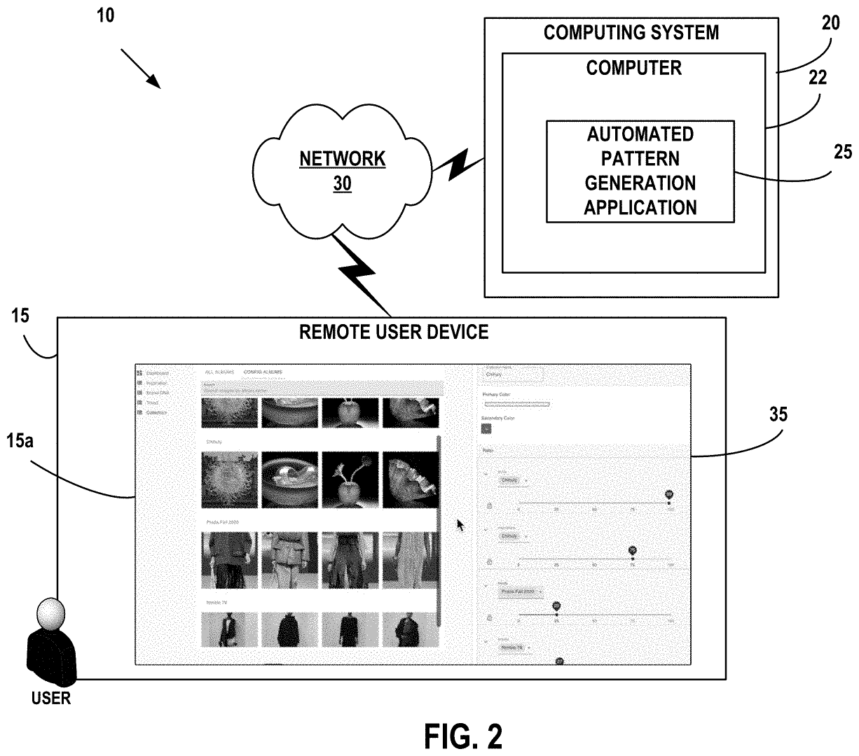

In an example embodiment, referring to FIG. 2, the automated pattern generation system is illustrated and designated by the numeral 10. In an example embodiment, the automated pattern generation system 10 includes a remote user device 15 and a computing system 20 that includes a computer 22 within which an automated pattern generation application 25 is stored, all of which are in communication via a network 30. Generally, a user provides the inputs via a graphical user interface 15a that is configured to display a window 35.

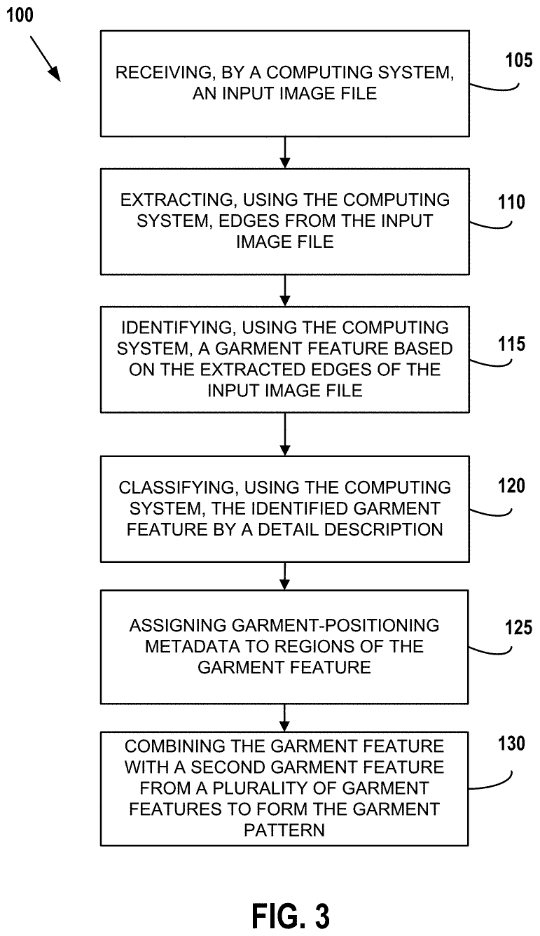

In an example embodiment, as illustrated in FIG. 3 with continuing reference to FIGS. 1-2, a method 100 of creating a garment pattern comprises receiving, by the computing system, an input image file at step 105; extracting, using the computing system, edges from the input image file at step 110; identifying, using the computing system, a garment feature based on the extracted edges of the input image file at step 115; classifying, using the computing system, the garment feature by detail description of the identified garment feature at step 120; assigning garment-positioning metadata to regions of the garment feature at step 125; and combining the identified garment feature with a second garment feature from a plurality of garment features to form the garment pattern at step 130.

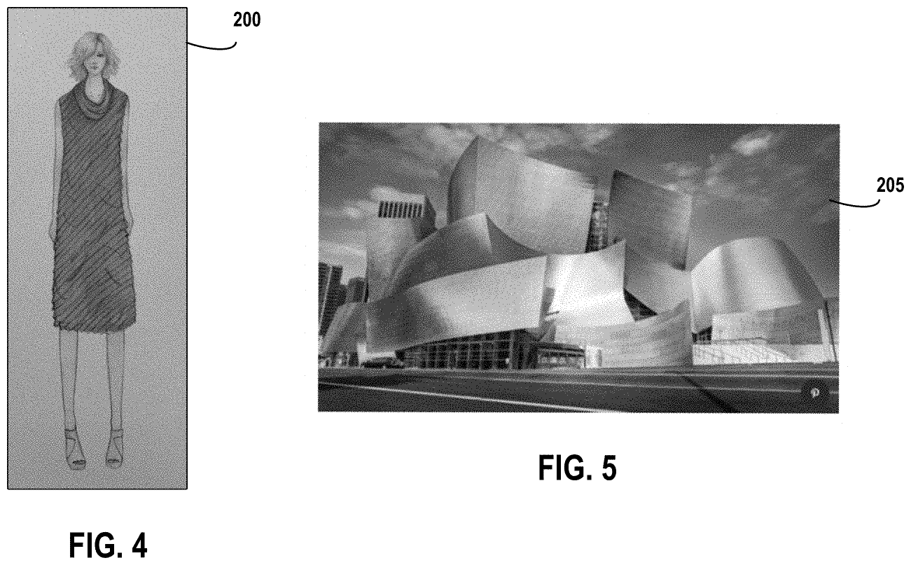

In some embodiment and at the step 105, the automated pattern generation application 25 receives an input image file. Generally, the input image file includes a sketch or a non-sketch image. The sketch may be created by hand by a designer. FIG. 4 illustrates an example of an input image file that includes a sketch 200. An example of an input image file that includes a non-sketch image is a photograph, such as a photograph of an architectural element; a naturally occurring landscape; a manmade landscape; an artwork; a painting; a brand's archives; naturally occurring matter; and man-made matter. FIG. 5 illustrates an example of an input image file that includes a non-sketch image 205. The non-sketch image 205 includes an image of a building having interesting design elements. In some embodiments, the step 105 also includes receiving designer selected trend images and/or brand DNA input. In some embodiments, the designer selected trend images are processed in a manner similar to the input image files. In some embodiments, the designer selected trend images are processed using AI that recognizes the images and extracts design features from the trend images. In some embodiments, the brand DNA input includes images of patterns that are associated with a brand of the user and are processed in a manner similar to the input image files. However, in other embodiments, extracting edges from the brand DNA input images is not required and instead, the brand DNA input includes historical data generated by the application 25 and saved or associated with the user and/or his or her brand. For example, the brand DNA input may include historical garment patterns approved or manufactured under a specific brand.

In some embodiments and at the step 110, the automated pattern generation application 25 extracts edges from the input image file. For an input image file having a sketch, in which the edges are defined by the lines rather than their boundaries, the automated pattern generation application 25 uses a contour tracing algorithm to find contours that make up the sketch. In one embodiment, to trace these contours the automated pattern generation application 25 first uses a standard thresholding algorithm and edge-based contour (e.g., OpenCV's threshold such as findContours). The automated pattern generation application 25 then, in some embodiments, finds segments of contours that run substantially parallel to one another, where parallel is defined by finding the angle between the two linear segments of the contours closest to each other. If that angle is below a threshold (e.g., 0.5 radians in one embodiment) and the segments are sufficiently close (e.g., 10 pixels in one embodiment), then segments are added from each contour iteratively on both sides of the seed contours until a pair of segments is found (on each side) that does not meet the threshold criterion either for distance or angle. In some embodiments, the midpoint of the two contours is then used to define the central contour of that particular line in the sketch. In some embodiments, extracting edges within the sketch includes identifying—using the automated pattern generation application 25 and an image processing and classification algorithm—contour segments that form a portion of the sketch; identifying a pair of contour segments as seed contours and positioning additional first and second contour segments next to the seed segments until boundary contour segments are identified, with the boundary contour segments being the extracted edges from the sketch. In some embodiments, identifying the pair of segment contours as the seed contours includes: identifying a first contour segment and a second contour segment; determining that the first and second contour segments are positioned, relative to one another, at an angle that is less than a threshold angle; and determining that the first and second contour segments are spaced, relative to one another, within a threshold of pixels. The threshold angle may be 0.2 radians, 0.3 radians, 0.4 radians, 0.5 radians, 0.6 radians, 0.7 radians, 0.8 radians, 0.9 radians or 1 radians. The threshold of pixels may be 70, pixels, 60 pixels, 50 pixels, 40 pixels, 30 pixels, 20 pixels, 15 pixels, 10 pixels, or 5 pixels. In some embodiments, identifying the boundary contour segments includes determining that outermost first and second contour segments are positioned, relative to one another, at an angle that exceeds the threshold angle; or determining that the outermost first and second contour segments are spaced, relative to one another, beyond the threshold of pixels. In some embodiments, each of the additional first contour segments is identical to the first contour segment and is positioned in parallel to the first contour segment at a set distance, and each of the additional second contour segments is identical to the second contour segment and is positioned in parallel to the second contour segment at the set distance. For an input image file having a non-sketch image or photographic images the automated pattern generation application 25 uses standard edge extraction techniques such as for example, Sobel, Canny, HoughLines, Laplacian, or other edge detection techniques.

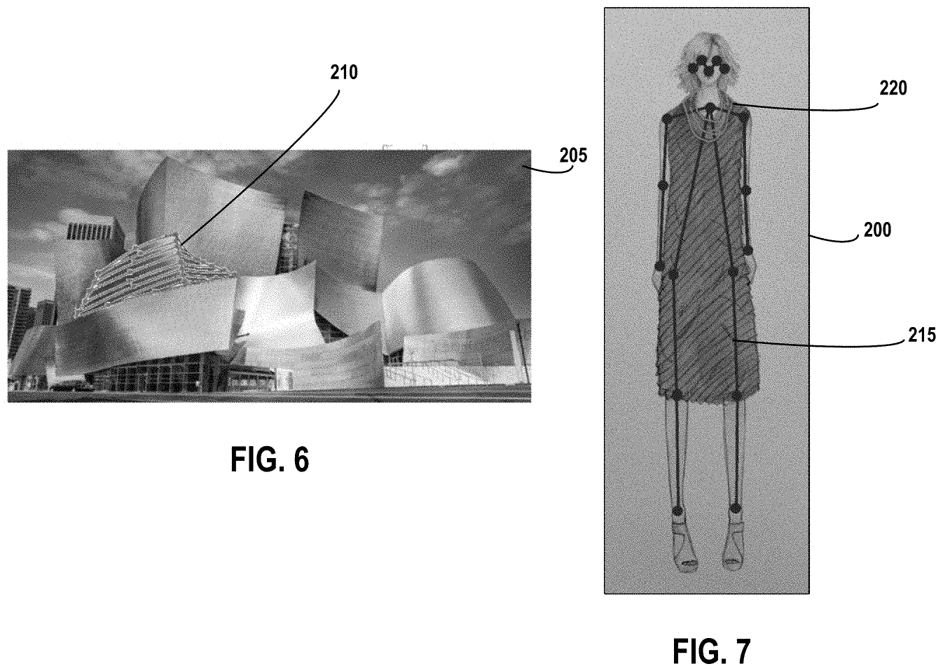

In some embodiments and at the step 115, the automated pattern generation application 25 identifies a garment feature based on the extracted edges of the input image file. Garment features can be identified based on instance segmentation and/or human pose estimation, among other techniques. Regarding edge grouping via instance segmentation, the automated pattern generation application 25 can use, for either sketch input images and non-sketch input images, instance segmentation techniques (e.g., MaskRCNN) that are trained to identify particular garment features. In some instances, the automated pattern generation application 25 uses a network trained to identify necklines (or other feature) and mask the image regions they are represented in in order to create a set of regions in the image that represent necklines (or other feature) above some confidence threshold. Often, the automated pattern generation application 25 uses a low confidence threshold in the case of non-sketch images to find patterns that are likely not themselves actual necklines (or other feature) but may have contours similar to a neckline. For example and referring to FIG. 6, the automated pattern generation application 25 identifies extracted edges 210 that has contours similar to a neckline. Groups of edges contained within this mask are combined to form a single design detail of the category defined by the instance segmentation label (i.e. neckline or sleeve). Regarding edge grouping via human pose estimation, in either image type (sketch or non-sketch), the automated pattern generation application 25 finds particular garment features by first using standard Human Pose Estimation techniques, then selects edge groups based on the regions of the body. For example, and as illustrated in FIG. 7, a skeleton 215 might be fitted to the sketch 200 in which there are extracted edges 220 near the neck and between the shoulder points. These edges 220 can then be grouped together and labeled as a neckline. As such, fitting a skeleton to the input image using a standard human pose estimation technique and identifying the garment feature based on the location of the extracted edges relative to the fitted skeleton is one way the automated pattern generation application 25 identifies a design feature based on the extracted edges. In some embodiments, a garment feature is one of a silhouette, a neckline, a sleeve, a waist silhouette, a hemline, a seam, an opening, a collar, a cuff, a neck detail, a waist detail, a hem detail, a print, and a fabric manipulation.

In some embodiments and at the step 120, the automated pattern generation application 25 classifies the identified garment feature by detail description. Edge groups maybe labeled as categories of design detail and can be classified as particular descriptors of that detail (i.e. V-neck, crew neck, bell sleeve, etc.) by rendering them alone and running the resulting image through a CNN trained to identify descriptors for that category of design detail. The automated pattern generation application 25 additionally uses this as a filtration step to remove candidate edges that do not strongly identify as any particular descriptor, based on the confidence value of the CNN. As such the automated pattern generation application 25 classifies a garment feature by the detail description via a convolutional neural network trained to identify the descriptor of the garment feature.

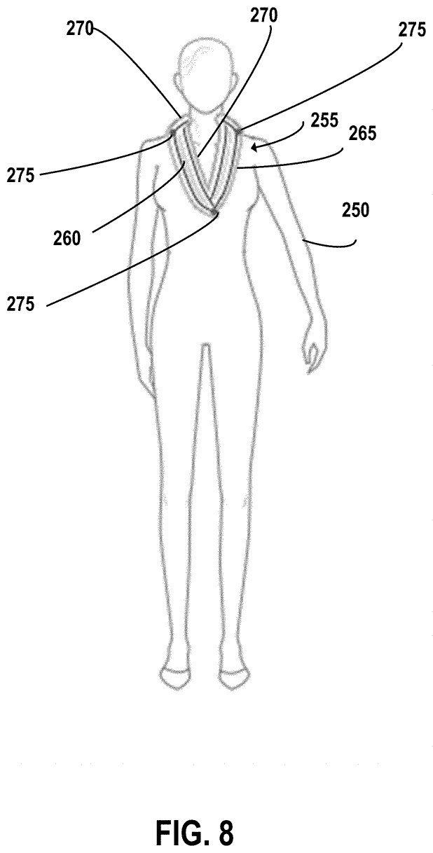

In some embodiments and at the step 125, the automated pattern generation application 25 assigns garment-positioning metadata to regions of the identified garment feature. Generally, the garment-positioning metadata comprises the internal metadata, the interior metadata, the exterior metadata, and the endpoint metadata. Assigning the garment-positioning metadata to regions of the garment feature includes placing the garment feature over a representation of a body form that would wear a garment that comprises the garment feature. FIG. 8 is an illustration of a representation of a body form 250 over which a garment feature 255 has been placed. Internal metadata 260 is assigned to a region of the garment feature that is wholly bounded by, and internal to, the garment feature 255. Interior metadata 265 is assigned to a region of the garment feature 255 that faces an interior of the garment. Exterior metadata 270 is assigned to region(s) of the garment feature 255 that faces an exterior of the garment. Endpoint metadata 275 is assigned to region(s) of the garment feature 255 that connects with a remainder of the garment. Generally, the edge of each contour of the detail is considered as to whether it primarily faces inside the body, outside the body, or other contours and those edges are defined as interior, exterior and internal respectively. Endpoints are found using contours that end at or near the convex hull of the design detail, and points where the contours cross the exterior lines of the body near the convex hull. These labels can also be manually assigned in cases where confidence is low for one of the steps. The steps 105-125 may be repeated multiple times to create a library of garment features, with each garment feature in the library having been assigned garment-positioning metadata.

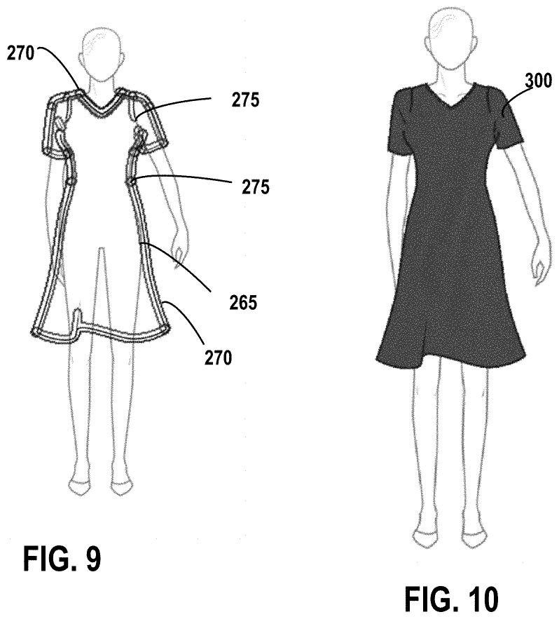

In some embodiment and at the step 130 the automated pattern generation application 25 combines the identified garment feature with a second garment feature from a plurality of garment features to form the garment pattern. Any number of garment features from the library can be combined to form the garment pattern. Generally, a garment pattern is defined as a set of descriptors. That is, a dress might be defined as a v-neck, a-line, bishop sleeves, bust pocket, which are examples of descriptors. For each of these descriptors, a matching design detail is selected from the library. If the body form for each of these design details is not the same as the form desired (for example if the pose or bodyshape is changed) the details are first transformed to fit that body form using keypoints on the form. In some embodiments, the automated pattern generation application 25 uses an affine transformation calculated from the nearest keypoints, but there are several options. Once all the details are placed on the body form, transformations and/or gap closer is used between the nearest endpoints of adjacent design details. Endpoints can be assigned directionality based on the vector between the center of their design detail and the endpoint to ensure that matched endpoints are facing approximately opposite directions. Generally, the automated pattern generation application 25 selects the second garment feature, often at least partially based on the body form. The automated pattern generation application 25 also positions the garment feature and the second garment features on the representation of the body form and then closes gaps between an endpoint of the garment feature and an adjacent endpoint of the second garment feature. The automated pattern generation application 25 then identifies regions of the garment pattern based on the combination of the garment-positioning metadata of the garment feature and the second garment feature. FIG. 9 illustrates the garment pattern with regions/metadata identified. That is, regions are found as defined by the combined set of design detail contours and labeled by a majority vote of their labeled edges. The regions of the garment pattern may include an interior region and an internal region. The automated pattern generation application 25 also fills the interior region and the internal region of the garment pattern with color, print, and/or texture. In some embodiments, contours that are too distant from interior and internal regions can be removed to trim any loose lines. The complete design can be placed on top of the body form to create the final sketch. FIG. 10 illustrates an example of a garment pattern 300 overlaid a representation of a body form.

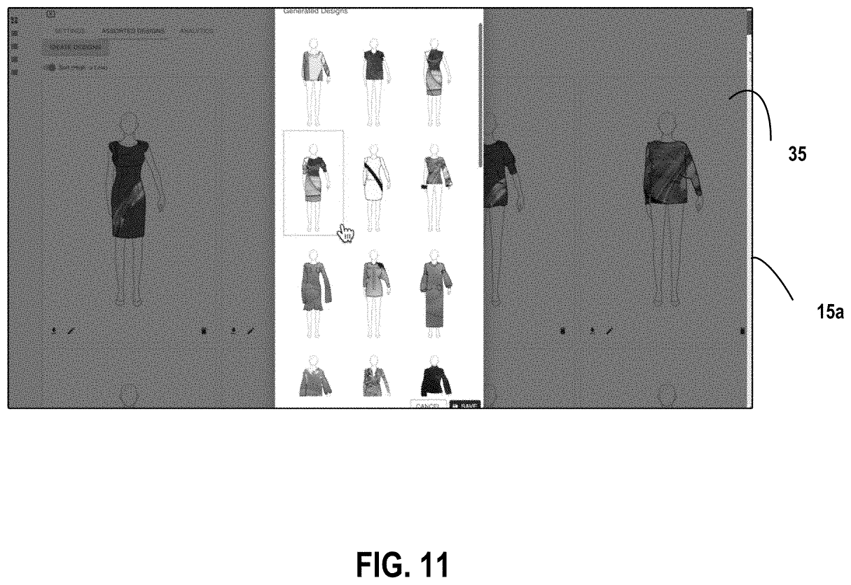

In some embodiments, the method 100 also includes generating a plurality of garment patterns based on the user inputs and displaying the garment patterns on a graphical user interface 15a. FIG. 11 is an illustration of the plurality of garment patterns being displayed on the GUI 15a in the window 35. The method 100 may also include receiving an input using the graphical user interface 15a, wherein the input in a different body form.

Based on the input received via the GUI 15a, the method 100 may also include the automated pattern generation application 25 generating a second garment pattern based on the different body form. For example, the automated pattern generation application 25 may select a third garment feature based on the different body form, positions the garment feature and the third garment feature on the representation of the different body form, closes gaps between an endpoint of the garment feature and an adjacent endpoint of the third garment feature, identifies regions of the second garment pattern based on the combination of the garment-positioning metadata of the garment feature and the third garment feature, and then fills the interior region and the internal region of the second garment pattern with color.

The method 100 may be altered in a variety of ways. For example, edges might be grouped into cohesive objects using an edge grouping process. Group continuity might be weighted higher in performing this grouping relative to semantic segmentation. Each grouping of edges might be represented in memory as a vector, representing features such as edge direction, inflection points, group size, edge width, etc. Each characterized edge group might be compared to a library of edge assets that represent parts of clothing (e.g., drawings of necklines, hoods, silhouettes, etc.). Groups with a high match score to a particular part of a garment might be selected and labeled as the matching garment part.

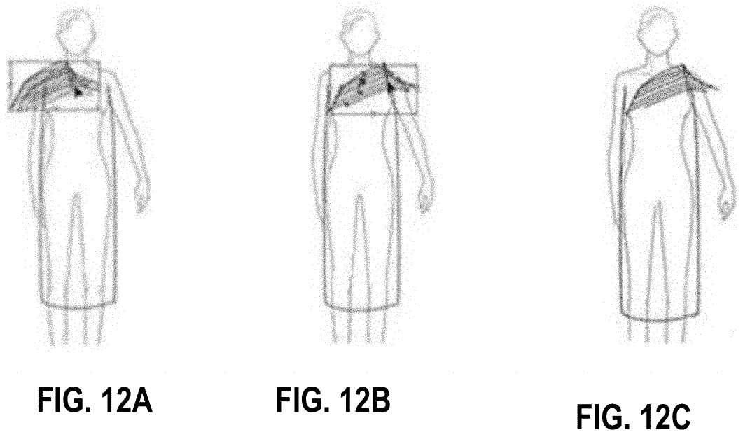

In some embodiments and during the step 130, each type of garment pattern (e.g., dress) might have a neckline, sleeves, a silhouette, and a hem. These assets can be pulled from a mix of a library of preconstructed assets and the novel edge groups extracted as described above. Edge groups may be scaled or otherwise distorted to better fit their placement on the garment, as illustrated in FIGS. 12A-12C. In some embodiments, the extracted edges are translated in to garment folds and may be positioned at different locations on a garment pattern.

Using the method 100 and/or the automated pattern generation system 10, the computing system 20 might be programmed to (1) identify a designed object (such as a building), (2) extract one or more features from the designed object, (3) determine a corresponding feature of a fashion item that corresponds to an extracted feature, and (4) generate a simulated view of the fashion item having that corresponding feature, a fashion pattern, and/or the fashion item itself.

The body model or body form could be selected from a library of body models or body forms. In other embodiments, the garment pattern can be displayed over more than one body forms, so that the designer or user can visualize how the garment pattern fits a variety of body forms. In other embodiments, the automated pattern generation application 25 rates, using a percentage value, how the garment pattern “fits” a specific body form. For example, if the user was looking for a garment pattern that flattered or otherwise fit a specific body form, the user can select that body form and the automated pattern generation application 25 provides a value of 0% to 100% that represents how well that garment pattern fits the body form. A set of design detail images might be selected from a library of design details. Examples include single structural elements such as the line of the hem, the line of the silhouette (e.g., sides of the garment), and/or the sleeves.

In some embodiments and during the step 130, each design detail asset can be transformed using virtual anchor points on the asset mapping to virtual anchor points on the model image. For example, the sides and hem might be transformed so that the garment is longer than originally drawn in the assets or the sleeve might be transformed to match the pose of the arm. Where gaps exist in the resultant drawing occur, a gap closure process can be used to result in a partially complete garment design.

In an example embodiment, the network 30 includes the Internet, one or more local area networks, one or more wide area networks, one or more cellular networks, one or more wireless networks, one or more voice networks, one or more data networks, one or more communication systems, and/or any combination thereof.

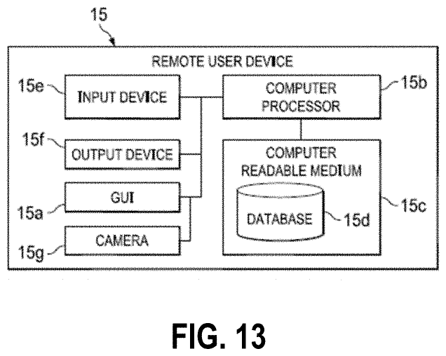

In an example embodiment, as illustrated in FIG. 13 with continuing reference to FIG. 2, the remote user device 15 includes a GUI 15a, computer processor 15b and a computer readable medium 15c operably coupled thereto. Instructions accessible to, and executable by, the computer processor 15b are stored on the computer readable medium 15c. A database 15d is also stored in the computer readable medium 15c. Generally, the GUI 15a can display a plurality of windows or screens to the user. The remote user device 15 also includes an input device 15e and an output device 15f. In some embodiments, the input device 15e and the output device 15f are the GUI 15a. In some embodiments, the user provides inputs to the system 10 via a window that is displayed on the GUI 15a. However, the input device 15e can also be a microphone in some embodiments and the output device 15f is a speaker. In several example embodiments, the remote user device 15 is, or includes, a telephone, a personal computer, a personal digital assistant, a cellular telephone or mobile phone, other types of telecommunications devices, other types of computing devices, and/or any combination thereof. In several example embodiments, the remote user device 15 includes a plurality of remote user devices.

In some embodiments and referring back to FIG. 2, the computer 22 is similar to the remote user device 15 in that the computer 22 also includes a computer processor and a computer readable medium operably coupled thereto. Instructions accessible to, and executable by, the computer processor are stored on the computer readable medium. A database is also stored in the computer readable medium of the computer 22. However, in some embodiments, the computer 22 is a special purpose computer and is not a generic computer.

In one or more example embodiments, the application 25 is stored in the computer readable medium of the computer 22 and in the computer readable medium 15e of the remote user device 15. In some embodiments, the application 25 includes and/or executes one or more web-based programs, Intranet-based programs, and/or any combination thereof. In an example embodiment, the application 25 includes a computer program including a plurality of instructions, data, and/or any combination thereof. In an example embodiment, the application is written in, for example, Hypertext Markup Language (“HTML”), Cascading Style Sheets (“CSS”), JavaScript, Extensible Markup Language (“XML”), asynchronous JavaScript and XML (“Ajax”), iOS, XCode, Swift, Android for mobile, and/or any combination thereof. In an example embodiment, the application 25 is a web-based application written in, for example, Java or Adobe Flex, which pulls real-time information from the remote user device 15. In some embodiments, the application 25 is or includes a mobile front-end application downloaded on the remote user device 15 of the user and a backend application stored or downloaded on the computer 22. Generally, the mobile front-end application communicates with the backend application.

In some embodiments and during the method 100, the backend portion of the application 25, which is stored on the computer 22, performs the steps 105-130 and the GUI 15a displays the results. In some embodiments, the remote user device 15 does not perform the steps 110-130 and as such, the performance of the remote user device 15 during the method 100 is improved. That is, the backend portion of the application 25 is executing the step 110-130 on the computer 22, which increases the processing capacity and speed of the remote user device 15 (i.e., less processing load on the remote user device 15, increased memory availability, and decreased power consumption on the remote user device 15) when compared to the front-end portion of the application 25 executing the step 110-130 on the remote user device 15.

As has been described, the application 25 obtains an image as an input, where the image is of a design element such as a unique building. The application 25 extracts essential design features from the image, determines how to represent those essential design features in a fashion object (e.g., a garment or wearable accessory), and computes how to generate a manufacturing pattern from the representations of the essential design features. In one embodiment, when a garment manufactured as a result of the computer process output, wearing the garment might invoke the design element(s) shown in the original image.

One benefit of the application 25 is that the computer process can process an image, extract relevant data, ignore irrelevant data, parse that data and group segments, add segments, etc. to result in an output image that distills down the elements of the original image in a form useful for further design use.

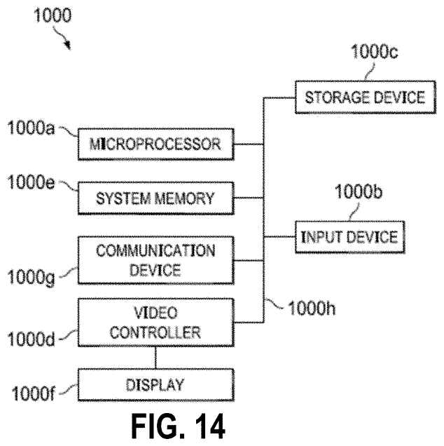

In an example embodiment, as illustrated in FIG. 14 with continuing reference to FIGS. 1-13, an illustrative node 1000 for implementing one or more of the example embodiments described above and/or illustrated in FIGS. 1-13 is depicted. The node 1000 includes a microprocessor 1000a, an input device 1000b, a storage device 1000c, a video controller 1000d, a system memory 1000e, a display 1000f, and a communication device 1000g all interconnected by one or more buses 1000h. In several example embodiments, the storage device 1000c may include a floppy drive, hard drive, CD-ROM, optical drive, any other form of storage device and/or any combination thereof. In several example embodiments, the storage device 1000c may include, and/or be capable of receiving, a floppy disk, CD-ROM, DVD-ROM, or any other form of non-transitory computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAs, smartphones and cell phones.

In several example embodiments, one or more of the components of the systems described above and/or illustrated in FIGS. 1-13 include at least the node 1000 and/or components thereof, and/or one or more nodes that are substantially similar to the node 1000 and/or components thereof. In several example embodiments, one or more of the above-described components of the node 1000, the system, and/or the example embodiments described above and/or illustrated in FIGS. 1-13 include respective pluralities of same components.

In several example embodiments, one or more of the applications, systems, and application programs described above and/or illustrated in FIGS. 1-13 include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that is capable of storing machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as floppy disks, flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The present disclosure introduces a method of creating a garment pattern that includes receiving, by a computing system, an input image; the computing system extracting edges within the input image; the computing system identifying a garment feature based on the extracted edges; the computing system classifying the garment feature by a detail description; the computing system assigning garment-positioning metadata to regions of the garment feature; and the computing system combining the garment feature with a second garment feature from a plurality of garment features to form the garment pattern. In one embodiment, the input image is a sketch; and wherein extracting, using the computing system, edges within the sketch includes: identifying, using the computing system and an image processing and classification algorithm, contour segments that form a portion of the sketch; identifying a pair of contour segments as seed contours, wherein identifying the pair of segment contours as the seed contours includes: identifying a first contour segment and a second contour segment; determining that the first and second contour segments are positioned, relative to one another, at an angle that is less than a threshold angle; and determining that the first and second contour segments are spaced, relative to one another, within a threshold of pixels; positioning additional first and second contour segments next to the seed segments until boundary contour segments are identified; wherein each of the additional first contour segments is identical to the first contour segment and is positioned in parallel to the first contour segment at a set distance; wherein each of the additional second contour segments is identical to the second contour segment and is positioned in parallel to the second contour segment at the set distance; wherein identifying the boundary contour segments includes: determining that outermost first and second contour segments are positioned, relative to one another, at an angle that exceeds the threshold angle; or determining that the outermost first and second contour segments are spaced, relative to one another, beyond the threshold of pixels; wherein the boundary contour segments are identified are the extracted edges from the sketch. In one embodiment, the input image is a non-sketch image; and wherein identifying, using the computing system, the garment feature based on the extracted edges includes using instance segmentation techniques trained to identify garment features. In one embodiment, the garment feature is one of a neckline, a sleeve, a hemline, a pocket, a waist detail, and a silhouette. In one embodiment, identifying, using the computing system, the garment feature based on the extracted edges includes: fitting a skeleton to the input image using a standard human pose estimation technique; and identifying the garment feature based on the location of the extracted edges relative to the fitted skeleton. In one embodiment, classifying, using the computing system, the garment feature by the detail description includes using a convolutional neural network trained to identify the descriptor of the garment feature. In one embodiment, assigning garment-positioning metadata to regions of the garment feature includes: placing the garment feature over a representation of a body form that would wear a garment that includes the garment feature; assigning internal metadata to a region of the garment feature that is wholly bounded by, and internal to, the garment feature; assigning interior metadata to a region of the garment feature that faces an interior of the garment; assigning exterior metadata to a region of the garment feature that faces an exterior of the garment; and assigning endpoint metadata to a region of the garment feature that connects with a remainder of the garment; wherein the garment-positioning metadata includes the internal metadata, the interior metadata, the exterior metadata, and the endpoint metadata. In one embodiment, each garment feature in the plurality of garment features has been assigned garment-positioning metadata; wherein the garment pattern is based on the body form; wherein combining the garment feature with a second garment feature to form the garment pattern includes: the computing system selecting the second garment feature based on the body form; the computing system positioning the garment feature and the second garment features on the representation of the body form; the computing system closing gaps between an endpoint of the garment feature and an adjacent endpoint of the second garment feature; the computing system identifying regions of the garment pattern based on the combination of the garment-positioning metadata of the garment feature and the second garment feature; wherein the regions of the garment pattern include an interior region and an internal region; and filling, using the computing system, the interior region and the internal region of the garment pattern with color. In one embodiment, the input image file is a photographic image including one of an architectural element; a naturally occurring landscape; a manmade landscape; naturally occurring matter; and man-made matter. In one embodiment, the method also includes displaying the garment pattern on a graphical user interface; receiving an input using the graphical user interface, wherein the input is a different body form; and the computing system generating a second garment pattern based on the different body form, including: the computing system selecting a third garment feature based on the different body form; the computing system positioning the garment feature and the third garment feature on the representation of the different body form; the computing system closing gaps between an endpoint of the garment feature and an adjacent endpoint of the third garment feature; the computing system identifying regions of the second garment pattern based on the combination of the garment-positioning metadata of the garment feature and the third garment feature; wherein the regions of the second garment pattern include an interior region and an internal region; and filling, using the computing system, the interior region and the internal region of the second garment pattern with color.

The present disclosure also introduces an apparatus for creating a garment pattern that includes a non-transitory computer readable medium having stored thereon a plurality of instructions, wherein the instructions are executed with at least one processor so that the following steps are executed: receiving an input image; extracting edges within the input image; identifying a garment feature based on the extracted edges; classifying the garment feature by a detail description; assigning garment-positioning metadata to regions of the garment feature; and combining the garment feature with a second garment feature from a plurality of garment features to form the garment pattern. In one embodiment, the input image is a sketch; and wherein extracting edges within the sketch includes: identifying, using an image processing and classification algorithm, contour segments that form a portion of the sketch; identifying a pair of contour segments as seed contours, wherein identifying the pair of segment contours as the seed contours includes: identifying a first contour segment and a second contour segment; determining that the first and second contour segments are positioned, relative to one another, at an angle that is less than a threshold angle; and determining that the first and second contour segments are spaced, relative to one another, within a threshold of pixels; positioning additional first and second contour segments next to the seed segments until boundary contour segments are identified; wherein each of the additional first contour segments is identical to the first contour segment and is positioned in parallel to the first contour segment at a set distance; wherein each of the additional second contour segments is identical to the second contour segment and is positioned in parallel to the second contour segment at the set distance; wherein identifying the boundary contour segments includes: determining that outermost first and second contour segments are positioned, relative to one another, at an angle that exceeds the threshold angle; or determining that the outermost first and second contour segments are spaced, relative to one another, beyond the threshold of pixels; wherein the boundary contour segments are identified are the extracted edges from the sketch. In one embodiment, the input image is a non-sketch image; and wherein identifying the garment feature based on the extracted edges includes using instance segmentation techniques trained to identify garment features. In one embodiment, the garment feature is one of a neckline, a sleeve, a hemline, a pocket, a waist detail, and a silhouette. In one embodiment, identifying the garment feature based on the extracted edges includes: fitting a skeleton to the input image using a standard human pose estimation technique; and identifying the garment feature based on the location of the extracted edges relative to the fitted skeleton. In one embodiment, classifying the garment feature by the detail description includes using a convolutional neural network trained to identify the descriptor of the garment feature. In one embodiment, assigning garment-positioning metadata to regions of the garment feature includes: placing the garment feature over a representation of a body form that would wear a garment that includes the garment feature; assigning internal metadata to a region of the garment feature that is wholly bounded by, and internal to, the garment feature; assigning interior metadata to a region of the garment feature that faces an interior of the garment; assigning exterior metadata to a region of the garment feature that faces an exterior of the garment; and assigning endpoint metadata to a region of the garment feature that connects with a remainder of the garment; wherein the garment-positioning metadata includes the internal metadata, the interior metadata, the exterior metadata, and the endpoint metadata. In one embodiment, each garment feature in the plurality of garment features has been assigned garment-positioning metadata; wherein the garment pattern is based on the body form; wherein combining the garment feature with a second garment feature to form the garment pattern includes: selecting the second garment feature based on the body form; positioning the garment feature and the second garment features on the representation of the body form; closing gaps between an endpoint of the garment feature and an adjacent endpoint of the second garment feature; identifying regions of the garment pattern based on the combination of the garment-positioning metadata of the garment feature and the second garment feature; wherein the regions of the garment pattern include an interior region and an internal region; and filling the interior region and the internal region of the garment pattern with color. In one embodiment, the input image file is a photographic image including one of an architectural element; a naturally occurring landscape; a manmade landscape; naturally occurring matter; and man-made matter. In one embodiment, the instructions are executed with the at least one processor so that the following steps are also executed: displaying the garment pattern on a graphical user interface; receiving an input using the graphical user interface, wherein the input is a different body form; and generating a second garment pattern based on the different body form, including: selecting a third garment feature based on the different body form; positioning the garment feature and the third garment feature on the representation of the different body form; closing gaps between an endpoint of the garment feature and an adjacent endpoint of the third garment feature; identifying regions of the second garment pattern based on the combination of the garment-positioning metadata of the garment feature and the third garment feature; wherein the regions of the second garment pattern include an interior region and an internal region; and filling the interior region and the internal region of the second garment pattern with color.

The present disclosure also introduces a non-transitory computer readable medium according to one or more aspects of the present disclosure.

Moreover, one or more of the example embodiments disclosed above and in one or more of FIGS. 1-14 may be combined in whole or in part with any one or more of the other example embodiments described above and in one or more of FIGS. 1-14.

Although several example embodiments have been disclosed in detail above and in one or more of FIGS. 1-14, the embodiments disclosed are example only and are not limiting, and those skilled in the art will readily appreciate that many other modifications, changes, and substitutions are possible in the example embodiments without materially departing from the novel teachings and advantages of the present disclosure. Accordingly, all such modifications, changes, and substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A method of creating a garment pattern comprising:
receiving, by a computing system, an input image;
the computing system extracting edges within the input image;
the computing system identifying a garment feature based on the extracted edges;
the computing system classifying the garment feature by a detail description;
the computing system assigning garment-positioning metadata to regions of the garment feature; and
the computing system combining the garment feature with a second garment feature from a plurality of garment features to form the garment pattern.

2. The method of claim 1,
wherein the input image is a sketch; and
wherein extracting, using the computing system, edges within the sketch comprises:
identifying, using the computing system and an image processing and classification algorithm, contour segments that form a portion of the sketch;
identifying a pair of contour segments as seed contours, wherein identifying the pair of segment contours as the seed contours comprises:
identifying a first contour segment and a second contour segment;
determining that the first and second contour segments are positioned, relative to one another, at an angle that is less than a threshold angle; and
determining that the first and second contour segments are spaced, relative to one another, within a threshold of pixels;
positioning additional first and second contour segments next to the seed segments until boundary contour segments are identified;
wherein each of the additional first contour segments is identical to the first contour segment and is positioned in parallel to the first contour segment at a set distance;
wherein each of the additional second contour segments is identical to the second contour segment and is positioned in parallel to the second contour segment at the set distance;
wherein identifying the boundary contour segments comprises:
determining that outermost first and second contour segments are positioned, relative to one another, at an angle that exceeds the threshold angle; or
determining that the outermost first and second contour segments are spaced, relative to one another, beyond the threshold of pixels;
wherein the boundary contour segments are identified are the extracted edges from the sketch.

3. The method of claim 1,
wherein the input image is a non-sketch image; and
wherein identifying, using the computing system, the garment feature based on the extracted edges comprises using instance segmentation techniques trained to identify garment features.

4. The method of claim 1,
wherein the garment feature is one of a neckline, a sleeve, a hemline, a pocket, a waist detail, and a silhouette.

5. The method of claim 1,
wherein identifying, using the computing system, the garment feature based on the extracted edges comprises:
fitting a skeleton to the input image using a standard human pose estimation technique; and
identifying the garment feature based on the location of the extracted edges relative to the fitted skeleton.

6. The method of claim 1, wherein classifying, using the computing system, the garment feature by the detail description comprises using a convolutional neural network trained to identify the descriptor of the garment feature.

7. The method of claim 1, wherein assigning garment-positioning metadata to regions of the garment feature comprises:
placing the garment feature over a representation of a body form that would wear a garment that comprises the garment feature;
assigning internal metadata to a region of the garment feature that is wholly bounded by, and internal to, the garment feature;
assigning interior metadata to a region of the garment feature that faces an interior of the garment;
assigning exterior metadata to a region of the garment feature that faces an exterior of the garment; and
assigning endpoint metadata to a region of the garment feature that connects with a remainder of the garment;
wherein the garment-positioning metadata comprises the internal metadata, the interior metadata, the exterior metadata, and the endpoint metadata.

8. The method of claim 7,
wherein each garment feature in the plurality of garment features has been assigned garment-positioning metadata;
wherein the garment pattern is based on the body form;
wherein combining the garment feature with a second garment feature to form the garment pattern comprises:
the computing system selecting the second garment feature based on the body form;
the computing system positioning the garment feature and the second garment features on the representation of the body form;
the computing system closing gaps between an endpoint of the garment feature and an adjacent endpoint of the second garment feature;
the computing system identifying regions of the garment pattern based on the combination of the garment-positioning metadata of the garment feature and the second garment feature;
wherein the regions of the garment pattern comprise an interior region and an internal region; and
filling, using the computing system, the interior region and the internal region of the garment pattern with color.

9. The method of claim 1, wherein the input image file is a photographic image comprising one of an architectural element; a naturally occurring landscape; a manmade landscape; naturally occurring matter; and man-made matter.

10. The method of claim 8, further comprising:
displaying the garment pattern on a graphical user interface;
receiving an input using the graphical user interface, wherein the input is a different body form; and
the computing system generating a second garment pattern based on the different body form, comprising:
the computing system selecting a third garment feature based on the different body form;
the computing system positioning the garment feature and the third garment feature on the representation of the different body form;
the computing system closing gaps between an endpoint of the garment feature and an adjacent endpoint of the third garment feature;
the computing system identifying regions of the second garment pattern based on the combination of the garment-positioning metadata of the garment feature and the third garment feature;
wherein the regions of the second garment pattern comprise an interior region and an internal region; and
filling, using the computing system, the interior region and the internal region of the second garment pattern with color.

11. An apparatus for creating a garment pattern comprising:
a non-transitory computer readable medium having stored thereon a plurality of instructions, wherein the instructions are executed with at least one processor so that the following steps are executed:
receiving an input image;
extracting edges within the input image;
identifying a garment feature based on the extracted edges;
classifying the garment feature by a detail description;
assigning garment-positioning metadata to regions of the garment feature; and
combining the garment feature with a second garment feature from a plurality of garment features to form the garment pattern.

12. The apparatus of claim 11,
wherein the input image is a sketch; and
wherein extracting edges within the sketch comprises:
identifying, using an image processing and classification algorithm, contour segments that form a portion of the sketch;
identifying a pair of contour segments as seed contours, wherein identifying the pair of segment contours as the seed contours comprises:
identifying a first contour segment and a second contour segment;
determining that the first and second contour segments are positioned, relative to one another, at an angle that is less than a threshold angle; and
determining that the first and second contour segments are spaced, relative to one another, within a threshold of pixels;
positioning additional first and second contour segments next to the seed segments until boundary contour segments are identified;
wherein each of the additional first contour segments is identical to the first contour segment and is positioned in parallel to the first contour segment at a set distance;
wherein each of the additional second contour segments is identical to the second contour segment and is positioned in parallel to the second contour segment at the set distance;
wherein identifying the boundary contour segments comprises:
determining that outermost first and second contour segments are positioned, relative to one another, at an angle that exceeds the threshold angle; or
determining that the outermost first and second contour segments are spaced, relative to one another, beyond the threshold of pixels;
wherein the boundary contour segments are identified are the extracted edges from the sketch.

13. The apparatus of claim 11,
wherein the input image is a non-sketch image; and
wherein identifying the garment feature based on the extracted edges comprises using instance segmentation techniques trained to identify garment features.

14. The apparatus of claim 11,
wherein the garment feature is one of a neckline, a sleeve, a hemline, a pocket, a waist detail, and a silhouette.

15. The apparatus of claim 11,
wherein identifying the garment feature based on the extracted edges comprises:
fitting a skeleton to the input image using a standard human pose estimation technique; and
identifying the garment feature based on the location of the extracted edges relative to the fitted skeleton.

16. The apparatus of claim 11, wherein classifying the garment feature by the detail description comprises using a convolutional neural network trained to identify the descriptor of the garment feature.

17. The apparatus of claim 11, wherein assigning garment-positioning metadata to regions of the garment feature comprises:
placing the garment feature over a representation of a body form that would wear a garment that comprises the garment feature;
assigning internal metadata to a region of the garment feature that is wholly bounded by, and internal to, the garment feature;
assigning interior metadata to a region of the garment feature that faces an interior of the garment;
assigning exterior metadata to a region of the garment feature that faces an exterior of the garment; and
assigning endpoint metadata to a region of the garment feature that connects with a remainder of the garment;
wherein the garment-positioning metadata comprises the internal metadata, the interior metadata, the exterior metadata, and the endpoint metadata.

18. The apparatus of claim 17,
wherein each garment feature in the plurality of garment features has been assigned garment-positioning metadata;
wherein the garment pattern is based on the body form;
wherein combining the garment feature with a second garment feature to form the garment pattern comprises:
selecting the second garment feature based on the body form;
positioning the garment feature and the second garment features on the representation of the body form;
closing gaps between an endpoint of the garment feature and an adjacent endpoint of the second garment feature;
identifying regions of the garment pattern based on the combination of the garment-positioning metadata of the garment feature and the second garment feature;
wherein the regions of the garment pattern comprise an interior region and an internal region; and
filling the interior region and the internal region of the garment pattern with color.

19. The apparatus of claim 11, wherein the input image file is a photographic image comprising one of an architectural element; a naturally occurring landscape; a manmade landscape; naturally occurring matter; and man-made matter.

20. The apparatus of claim 18, wherein the instructions are executed with the at least one processor so that the following steps are also executed:
displaying the garment pattern on a graphical user interface;
receiving an input using the graphical user interface, wherein the input is a different body form; and
generating a second garment pattern based on the different body form, comprising:
selecting a third garment feature based on the different body form;
positioning the garment feature and the third garment feature on the representation of the different body form;
closing gaps between an endpoint of the garment feature and an adjacent endpoint of the third garment feature;
identifying regions of the second garment pattern based on the combination of the garment-positioning metadata of the garment feature and the third garment feature;
wherein the regions of the second garment pattern comprise an interior region and an internal region; and
filling the interior region and the internal region of the second garment pattern with color.
